(19) United States
(12) Patent Application Publication
(10) Pub. No.: US 2009/0183936 A1
(43) Pub. Date: Jul. 23, 2009

(54) Thermal management system module for fuel cell vehicle

(75) Inventors: Seong Kyun Kim, Seoul (KR); Dong Su Yang, Gyeonggi-do (KR); Seung Yong Lee, Gyeonggi-do (KR); Hwan Ik Kim, Gyeonggi-do (KR); Su Dong Han, Gyeonggi-do (KR); Seng Jong Lyoo, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/290,145

(22) Filed: Oct. 28, 2008

(30) Foreign Application Priority Data
Dec. 13, 2007 (KR) 10-2007-0130350

(51) Int. Cl. B60K 11/04

(52) U.S. Cl. 180/68.4

(57) ABSTRACT

A thermal management system module for a fuel cell vehicle includes its component parts mounted on a single mounting frame, thus increasing space usage and layout efficiency, reducing overall weight and manufacturing costs and improving piping and wiring efficiency and assembling efficiency of the thermal management system.

### CROSS-REFERENCE TO RELATED APPLICATION

This application claims under 35 U.S.C. §119(a) the benefit of Korean Patent Application No. 10-2007-0130350 filed Dec. 13, 2007, the entire contents of which are incorporated herein by reference.

### BACKGROUND

(a) Technical Field

The present invention relates to a thermal management system module for a fuel cell vehicle, in which respective component parts of the system are mounted on a single mounting frame to be modularized.

(b) Background Art

A fuel cell vehicle uses as a fuel hydrogen supplied from a hydrogen tank to a fuel cell stack to produce electricity, and the electricity produced by the fuel cell stack is used to drive an electric motor, thus causing the vehicle to travel.

In general, the fuel cell system is an electricity generation system that does not convert chemical energy of a fuel into heat by combustion, but electrochemically converts the chemical energy directly into electric energy in the fuel cell stack.

The fuel cell system generally comprises the fuel cell stack for generating electricity, a fuel supply system for supplying hydrogen as a fuel to the fuel cell stack, an air supply system for supplying oxygen in the air, which is an oxidizing agent required for an electrochemical reaction, to the fuel cell stack, and a thermal management system (TMS) for removing reaction heat of the fuel cell stack to the outside of the fuel cell system, controlling the operation temperature of the fuel cell stack, and performing a water management function.

The fuel cell system having the above configuration generates electricity by the electrochemical reaction of hydrogen as a fuel and oxygen in the air and exhausts heat and water as reaction by-products.

Such a fuel cell vehicle includes basic elements such as a drive motor and a secondary battery (or super capacitor) and peripheral systems such as the hydrogen supply system, the air supply system, and the thermal management system so as to generate electricity by supplying the hydrogen used as a fuel to the fuel cell, store the electricity generated by the fuel cell in the secondary battery, and drive the drive motor with the electricity generated by the fuel cell or with the electricity stored in the secondary battery, thus causing the vehicle to travel.

Meanwhile, the thermal management system is provided in the fuel cell vehicle to enable the operation of the fuel cell stack under various operating environments, and the thermal management system includes a pump, a heater, a thermostat, sensors, and a controller. Conventionally, the above parts included in the thermal management system are dispersedly arranged in the vehicle.

FIG. 1 is a plan view showing a dispersed arrangement of respective parts of a conventional thermal management system, and FIG. 2 is a perspective view showing a conventional arrangement of a thermostat, a deionizer, and a muffler.

FIG. 1 shows the mounting positions of a radiator 31, a cooling fan 32, a heater 13, a controller 15, and a cooling pump 12, and FIG. 2 shows a thermostat 14, a deionizer 17, and a muffler 16 mounted on the periphery of electric equipment 3.

As shown in FIGS. 1 and 2, conventionally, the respective parts included in the thermal management system for the fuel cell vehicle are dispersedly arranged in an engine room and on a vehicle underfloor. Accordingly, such a structure in which a great number of parts are dispersedly arranged in a limited engine room and in other spaces of the vehicle has some disadvantages in terms of layout efficiency and space utilization.

Especially, in the case where the respective parts are dispersedly arranged as described above, the hoses and wires for connecting the respective parts are lengthened and also the number of the hoses and wires is increased, which deteriorates space utilization, requires excessive number of parts, and increases overall weight and manufacturing cost, and the like.

Moreover, since the respective parts are dispersedly disposed and assembled at their respective positions and then the hoses or cables are connected between the dispersedly arranged parts, piping, wiring and assembling processes become difficult.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides a thermal management system module for a fuel cell vehicle, wherein component parts of the thermal management system for operation of a fuel cell stack are mounted on a single mounting frame to be modularized.

In a preferred embodiment, the mounting frame is mounted on a vehicle body frame in an engine room such that the modularized component parts are mounted in the engine room. In this embodiment, the fuel cell stack may, preferably, be mounted on a top side or a bottom side of the mounting frame such that the fuel cell stack and the mounting frame are stacked in the engine room. A high-voltage electric equipment may, suitably, be mounted on a top side or a bottom side of the mounting frame such that the high-voltage electric equipment and the mounting frame are stacked in the engine room.

In case of a vehicle having a monocoque structure, the mounting frame may be mounted on a side member that is a central support of a vehicle such that the modularized component parts are mounted in the engine room.

In this case, the fuel cell stack may, preferably, be mounted on a top side or a bottom side of the mounting frame such that the fuel cell stack and the mounting frame are stacked in the engine room. A high-voltage electric equipment may, suitably, be mounted on a top side or a bottom side of the mounting frame such that the high-voltage electric equipment and the mounting frame are stacked in the engine room.

In another preferred embodiment, the mounting frame may be mounted under or below a bottom side of a vehicle underfloor such that the modularized component parts are mounted under or below a bottom side of the vehicle underfloor. In this embodiment, the fuel cell stack may, preferably, be mounted under or below a bottom side of the vehicle underfloor such that the mounting frame is mounted in front of or behind the fuel cell stack. In this case, the component parts of the thermal management system may comprise a cooling pump and a heater, which are connected to a radiator provided in front of the vehicle and the fuel cell stack by means of hoses, thus providing a cooling circuit.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a plan view showing a dispersed arrangement of respective parts of a conventional thermal management system;

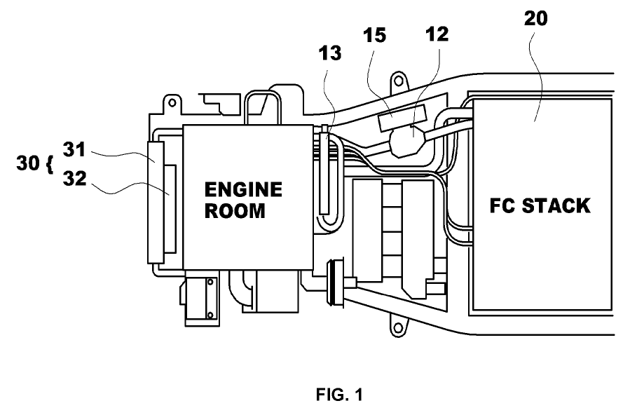

FIG. 2 is a perspective view showing a conventional arrangement of a thermostat, a deionizer, and a muffler;

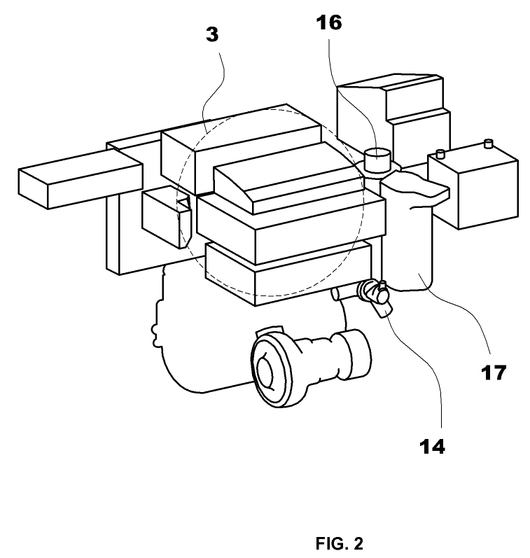

FIG. 3 is a side view showing an arrangement of a thermal management system module in accordance with an embodiment of the present invention;

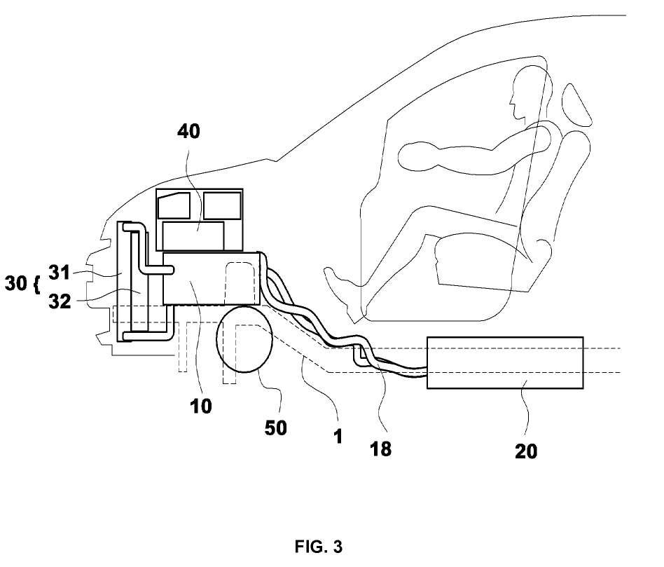

FIG. 4 is a plan view showing an arrangement of the thermal management system module in accordance with an embodiment of the present invention;

FIG. 5 is a configuration diagram showing a modularized structure of the thermal management system module in accordance with an embodiment of the present invention; and

FIG. 6 is a plan view showing a mounted state of the thermal management system module in accordance with an embodiment of the present invention.

Reference numerals set forth in the Drawings includes reference to the following elements as further discussed below:

| 1: | vehicle body frame | 2: | underfloor |
|---|---|---|---|
| 10: | thermal management system module | | |
| 11: | mounting frame | 12: | cooling pump |
| 13: | heater | 14: | thermostat |
| 15: | controller | 16: | muffler |
| 17: | deionizer | 18: | hose |
| 20: | fuel cell stack | 30: | cooling module |
| 31: | radiator | 32: | cooling fan |
| 40: | high-voltage electric equipment | 50: | drive motor |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

The present invention aims at providing a thermal management system module for a fuel cell vehicle including a fuel cell, a drive motor, a secondary battery (or super capacitor), a hydrogen supply system, an air supply system, a radiator, a cooling fan, and a thermal management system, in which the respective component parts of the thermal management system for operation of the fuel cell are mounted on a single mounting frame to be modularized.

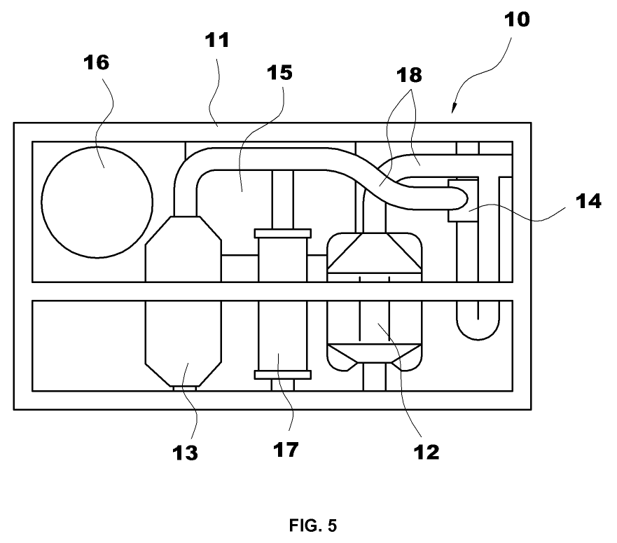

As shown in FIG. 5, the thermal management system module 10 in accordance with an embodiment of the present invention is configured by mounting the respective component parts thereof on a mounting frame 11 at predetermined positions to form a module.

Normally, a thermal management system includes various component parts such as, for example, a cooling pump 12, a heater 13, a thermostat 14 and sensors, a controller 15, a muffler 16, a deionizer 17, and related hoses 18 and wires (cables). These components parts are fixedly mounted on the mounting frame 11, thus constituting the integrated thermal management system module 10.

The thermal management system module 10 has a cooling function for dissipating heat generated during operation of a fuel cell stack 20, a heating function for enabling the operation of the fuel cell stack 20 which is cooled, and a deionizing function for increasing the electricity generation efficiency of the fuel cell stack 20. To this end, the cooling pump 12, the heater 13, the deionizer 17, the controller 15 for the pump and heater, the thermostat 14, the hoses 18 and wires (cables), and sensors are provided in the thermal management system module 10 so as to perform the above functions.

The respective component parts are fixedly mounted on the mounting frame 11 by brackets, sub-frames, fasteners, or other fastening means, or by welding, and then the hoses 18 connected to the respective component parts are connected to each other in accordance with their uses or connected to the radiator 31 or the fuel cell stack 20 after being mounted on the vehicle body.

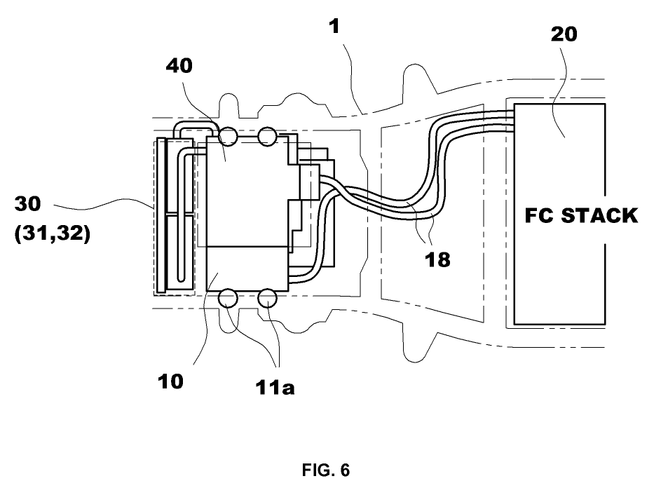

In a preferred embodiment, the mounting frame 11 may be mounted on a top side of a vehicle body frame 1 to be installed in an engine room. In this case, as shown in FIG. 6, the mounting frame 11 may be mounted on the vehicle body frame 1 by connecting a plurality of connecting ends 11a thereof to the vehicle body frame 1 using known methods such as a bolt tightening method, a welding method, a bracket mounting method, and the like.

In case of a vehicle having a monocoque structure, in mounting the thermal management system module 10 on the vehicle body frame 1, the vehicle body frame 1 may be substituted with a side member that is a central support of the vehicle.

Suitably, the thermal management system 10 and the fuel cell stack 20 may be mounted in the engine room such that the fuel cell stack 20 and the thermal management system module 10 are stacked in the engine room, thus providing an optimized cooling circuit.

Like this, since the components parts are modularized in a single thermal management system module 10, it is possible to prevent the respective components parts from being dispersedly arranged, and thus it is possible to solve various problems caused by the dispersed arrangement. Especially, there are further advantages in that the number and length of the hoses connected between the fuel cell stack and the radiator is decreased and the piping and wiring efficiency is improved.

Suitably, a high-voltage electric equipment 40 such as a power distribution unit (PDU) and a high voltage junction box may be disposed on a top side of the thermal management system module 10 disposed in the engine room. Furthermore, preferably, a cooling module 30 including the radiator 31 and the cooling fan 32 is disposed in front of the vehicle and the fuel cell stack 20 is disposed on a bottom side of a vehicle underfloor 2.

In the event that the high-voltage electric equipment 40 is mounted on the thermal management system module 10 as described above, it is possible to simultaneously assemble the high-voltage electric equipment 40 and the thermal management system module 10 to the vehicle body.

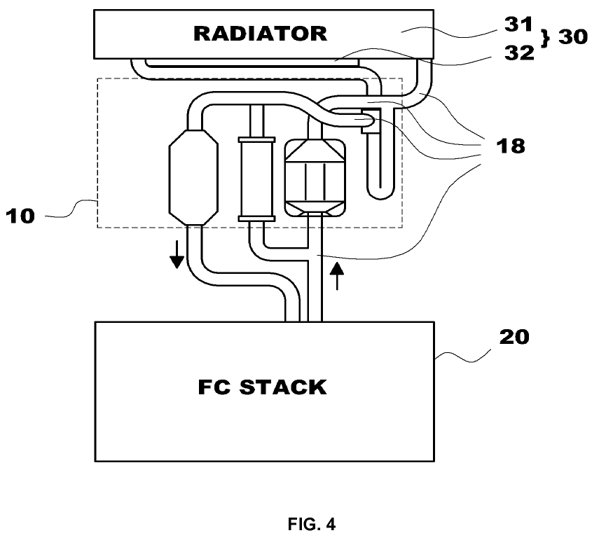

As shown in FIG. 4, the cooling pump 12 and the heater 13 of the thermal management system module 10 are connected to the radiator 31 of the cooling module 30 and the fuel cell stack 20 positioned in front of the vehicle by the hoses 18, respectively.

Accordingly, water heated in the fuel cell stack 20 is pumped by the cooling pump 12 and fed into the radiator 31 to be cooled, and the water cooled in the radiator 31 is temperature controlled by the heater 13 and returned to the fuel cell stack 20.

As described above, since the thermal management system module 10 in which the respective component parts are modularized is disposed in the engine room and the fuel cell stack 20 is disposed under or below the vehicle underfloor 2, the present invention provides an optimized cooling circuit arranged from the radiator 31 of the cooling module 30 positioned in front of the vehicle to the fuel cell stack 20 on the underfloor 2 via the thermal management system module 10 in the engine room.

In the case where the thermal management system module 10 is disposed between the radiator 31 and the fuel cell stack 20 as described above, there is a significant advantage in that the hose arrangement is minimized.

In an alternative embodiment of the present invention, the thermal management system module 10 and the fuel cell stack 20 may be disposed under or below the vehicle underfloor 2 with the thermal management system module 10 positioned in front of or behind the fuel cell stack 20.

As described above, the present thermal management system modules increase space utilization and layout efficiency, decrease the number of parts, overall weight and manufacturing cost, and the like, and improve piping, wiring and assembling efficiency of the thermal management system.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A thermal management system module for a fuel cell vehicle, wherein component parts of the thermal management system for operation of a fuel cell stack are mounted on a single mounting frame to be modularized.

2. The thermal management system module of claim 1, wherein the mounting frame is mounted on a vehicle body frame in an engine room such that the modularized component parts are mounted in the engine room.

3. The thermal management system module of claim 2, wherein the fuel cell stack is mounted on a top side or a bottom side of the mounting frame such that the fuel cell stack and the mounting frame are stacked in the engine room.

4. The thermal management system module of claim 2, wherein a high-voltage electric equipment is mounted on a top side or a bottom side of the mounting frame such that the high-voltage electric equipment and the mounting frame are stacked in the engine room.

5. The thermal management system module of claim 1, wherein the mounting frame is mounted on a side member that is a central support of a vehicle having a monocoque structure such that the modularized component parts are mounted in the engine room.

6. The thermal management system module of claim 5, wherein the fuel cell stack is mounted on a top side or a bottom side of the mounting frame such that the fuel cell stack and the mounting frame are stacked in the engine room.

7. The thermal management system module of claim 5, wherein a high-voltage electric equipment is mounted on a top side or a bottom side of the mounting frame such that the high-voltage electric equipment and the mounting frame are stacked in the engine room.

8. The thermal management system module of claim 1, wherein the mounting frame is mounted under or below a bottom side of a vehicle underfloor such that the modularized component parts are mounted under or below a bottom side of the vehicle underfloor.

9. The thermal management system module of claim 8, wherein the fuel cell stack is mounted under or below a bottom side of the vehicle underfloor such that the mounting frame is mounted in front of or behind the fuel cell stack.

10. The thermal management system module of claim 9, wherein the component parts of the thermal management system comprise a cooling pump and a heater, which are connected to a radiator provided in front of the vehicle and the fuel cell stack by means of hoses, thus providing a cooling circuit.
